(19) United States
(12) Patent Application Publication
(10) Pub. No.: US 2011/0051030 A1
(43) Pub. Date: Mar. 3, 2011

(54) LIQUID CRYSTAL DISPLAY DEVICE

(75) Inventors: Chien-Hsiung Chen, Taipei City (TW); Keng-Chih Liu, Taipei City (TW); Shih-Jen Liu, Taipei City (TW)

(73) Assignee: COMPAL ELECTRONICS, INC., Taipei City (TW)

(21) Appl. No.: 12/577,217

(22) Filed: Oct. 12, 2009

(30) Foreign Application Priority Data
Aug. 27, 2009 (TW) 98128910

(51) Int. Cl. G02F 1/1333

(52) U.S. Cl. 349/58

(57) ABSTRACT

A liquid crystal display device installed in a panel having an accommodating cavity is provided. The liquid crystal display device includes a display screen, two sliding supporters and an actuator. The display screen has a display surface parallel to the panel. The two sliding supporters connect the display screen. The actuator is disposed on a frame accommodated in the accommodating cavity to drive the two sliding supporters and the display screen moving away from the panel horizontally from a horizontal position to a destination position.

### CROSS-REFERENCE TO RELATED APPLICATION

This application claims the priority benefit of Taiwan application serial no. 98128910, filed on Aug. 27, 2009. The entirety of the above-mentioned patent application is hereby incorporated by reference herein and made a part of specification.

### BACKGROUND OF THE INVENTION

1. Field of the Invention

The present invention generally relates to a liquid crystal display device, and more particularly, to an automotive liquid crystal display device.

2. Description of Related Art

With the advantages of slim and light, liquid crystal display device are broadly used in a car for being as an automotive display device. The conventional automotive display device is installed for example at the back side of the pillow of the seat, on the inside wall of the car roof or in the panel besides the driving seat, through specific installation racks. However, the installation racks affects the artistic appearance and surroundings in the car and further limit the available inner space of the car. Therefore, an electric hidden display screen driven by an electrical driving mechanism is proposed. The display screen protrudes outward from the panel and flips up in using to show images. In addition, the display screen is retracted and hidden within the panel without being used to improve the artistic appearance in the car and reduce the risk of being stolen or damaged.

However, the horizontal moving stroke of the display screen protruding outward the panel is substantially the body length thereof. The long horizontal stroke of the display screen may lead the display screen striking the shift lever in front of the panel, and thus the altitude of the display screen should be taken into account in design. Furthermore, the display screen obstructs devices such as a stereo host, buttons of air condition or an air outlet, which makes the user feel inconvenient in operating the above devices, and accordingly the original design of the panel needs to be amended. Moreover, in order to retract and hide the display screen into the panel, the size of the display screen is fabricated to be smaller than a standard size of an automotive stereo panel (2DIN). In other words, minimizing the size of the display screen is restricted.

The convention electric hidden display screen has the above mentioned drawbacks. Additionally, the electric driving mechanism of the convention electric hidden display screen is complicated and suffers in high failure probability, and thus reduces the lifetime of the convention electric hidden display screen.

### SUMMARY OF THE INVENTION

The present invention provides a liquid crystal display device suitable for being installed to an automotive panel and driving a display screen to a predicted position by an actuator to overcome the above problems.

The present invention provides a liquid crystal display device with a host hidden in the back of a display screen to save space in a panel.

The present invention provides a liquid crystal display device installed in a panel having an accommodating cavity. The liquid crystal display device includes a display screen, two sliding supporters and an actuator.

The display screen has a display surface parallel to the panel. The two sliding supporters connect the display screen. The actuator is disposed on a frame accommodated in the accommodating cavity to drive the two sliding supporters and the display screen moving away from the panel horizontally from a horizontal position to a destination position.

In an embodiment, the frame has a first guiding portion, and an actuated block of the actuator is slidably coupled to the first guiding portion.

In an embodiment, the actuated block has a horizontal sliding slot, and the first guiding portion is installed in the horizontal sliding slot for supporting the actuated block.

In an embodiment, the actuator has a transmitting gear coupled to a rack of the actuated block for driving the actuated block.

In an embodiment, the actuator has an electric motor to drive the transmitting gear revolving.

In an embodiment, the actuated block is provided with a vertical axle, and a sleeve of the sliding supporter is disposed on the axle such that the actuated block connects and drives the sliding supporter.

In an embodiment, the sleeve moves along the vertical axle to adjust the altitude of the sliding supporter.

In an embodiment, the frame has a second guiding portion, and the sliding supporter is slidably coupled to the second guiding portion.

In an embodiment, the sliding supporter has a rail, and the second guiding portion is installed in the rail for supporting the sliding supporter.

In an embodiment, the rail has a horizontal section and an inclined section, when the display screen is on the horizontal position and moving outward the panel, the second guiding portion is in the horizontal section, and when the display screen approaches the destination position, the second guiding portion is in the inclined section.

In an embodiment, the display screen is provided with a start key for enabling the actuator to drive the display screen moving from the horizontal position to the destination position.

In an embodiment, the display screen is provided with a return key for enabling the actuator to drive the display screen moving from the destination position back to the horizontal position.

In an embodiment, the display screen obstructs a host when locating at the horizontal position, while the display screen exposes the host with an opening when locating at the destination position.

In an embodiment, the host is installed in the frame and electrically connected to the display screen.

In an embodiment, a size of the display screen conforms to a standard size of a 2DIN automotive stereo panel.

In an embodiment, a size of the host conforms to a standard size of an 1DIN automotive stereo panel.

Accordingly, the liquid crystal display device drives the display screen outward the panel from the horizontal position to the destination position. Comparing with the conventional liquid crystal display devices, the display screen of the present invention has a shorter stroke and no more strike the shift lever in front of the panel. Furthermore, the display surface of the display screen always faces the user and the liquid crystal display device performs without flipping the display screen and thus devices on top of the display screen are no more obstructed.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 illustrates a schematic view of a liquid crystal display device according to one embodiment of the invention.

FIG. 2A is a top view of the liquid crystal display device as shown in FIG. 1.

FIG. 2B is a bottom view of the liquid crystal display device as shown in FIG. 1.

FIGS. 3A-3F show operation process of a liquid crystal display device according to one embodiment of the invention.

### DESCRIPTION OF EMBODIMENTS

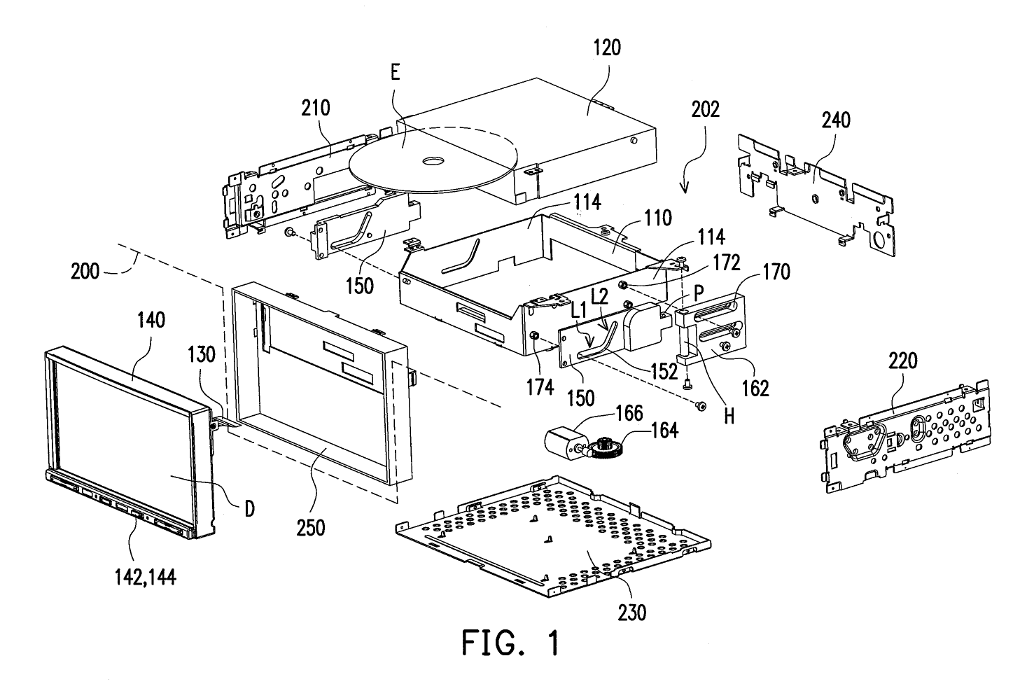

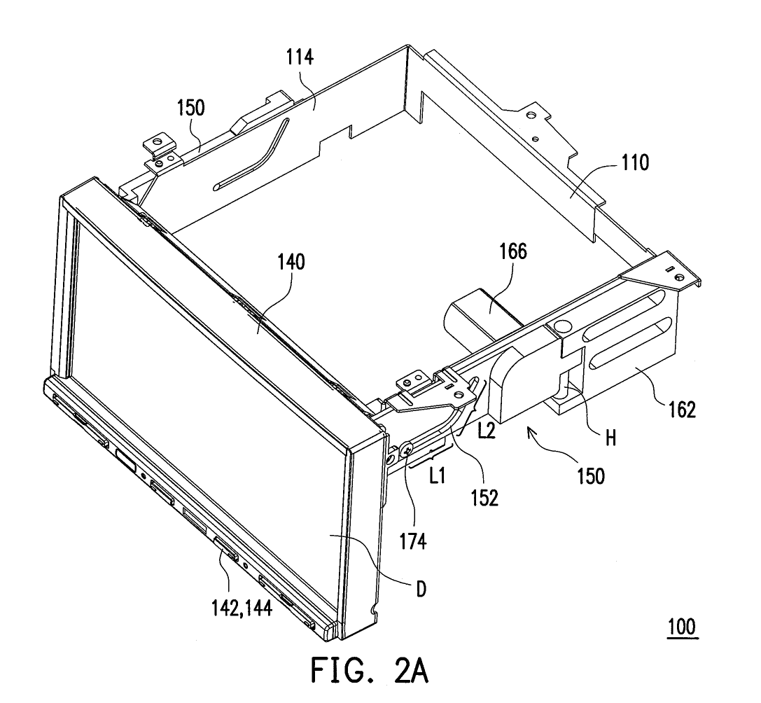

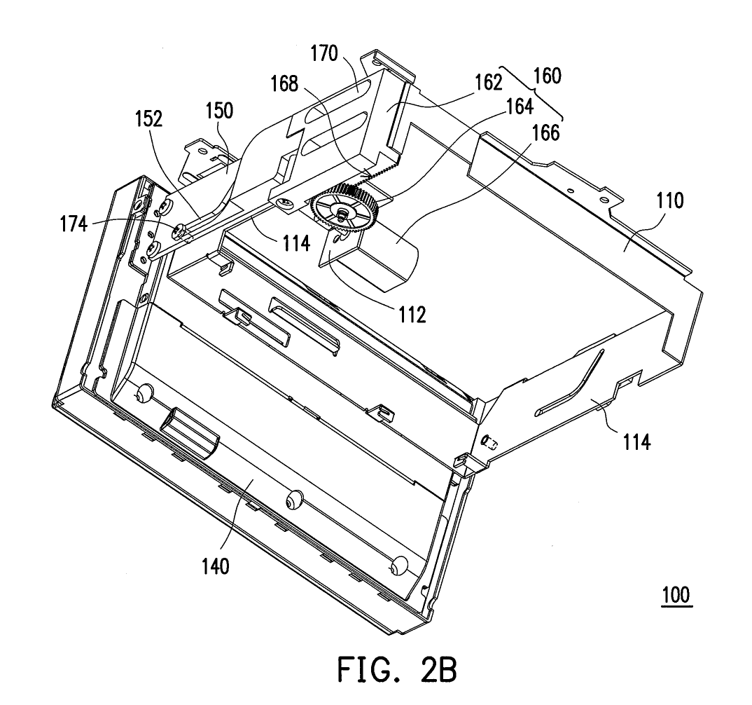

FIG. 1 illustrates a schematic view of a liquid crystal display device according to one embodiment of the invention. FIG. 2A is a top view of the liquid crystal display device as shown in FIG. 1. FIG. 2B is a bottom view of the liquid crystal display device as shown in FIG. 1.

Referring to FIGS. 1, 2A and 2B, the liquid crystal display device 100 is installed in a reserved space, such as in a panel 200 beside the driver seat, for being as an automotive display device, by which the passenger or the driver can watch video program, or surf the internet, email, and transmit motion image through mobile communication system.

The panel 200 has a plurality of fixing plates, including a left side plate 210, a right side plate 220, a cover plate (not shown), a bottom plate 230 and a back plate 240. These fixing plates form an accommodating cavity 202 for accommodating a frame 110 and a host 120. The host 120 is fixed in the frame 110 and electrically connected to a display screen 140 through a flexible cable 130 to display video program or mobile communication information. The host 120 may be an optical disc drive or an automotive host. In addition, the panel 200 is provided with a screen supporting rack 250 at its opening for fixing the display screen 140 at the opening of the panel 200. The screen supporting rack 250 is connected to the driving mechanism in the accommodating cavity 202 to drive the display screen 140 moving to a predetermined position. Components of the driving mechanism are illustrated in detail in the following paragraphs. Referring to FIGS. 1, 2A and 2B, the driving mechanism includes two sliding supporters 150 and an actuator 160. The actuator 160 includes an actuated block 162, a transmitting gear 164 and an electric motor 166. The electric motor 166 and the transmitting gear 164 are fixed on a plate 112 of the frame 110, and the actuated block 162 is movably disposed on a side plate 114 of the frame 110, as shown in FIG. 2B. The electric motor 166 drives the transmitting gear 164 revolving, and then the transmitting gear 164 drives the actuated block 162 moving along a straight line on the side plate 114 of the frame 110. In detail, the actuated block 162 may have a rack 168, and the transmitting gear 164 is coupled to the rack 168 to drive the actuated block 162. Furthermore, the actuated block 162 has two horizontal sliding slots, and the frame 110 has a first guiding portion 172, such as a guiding pin, but not limited thereto. The first guiding portion 172 is arranged in the horizontal sliding slot 170 for supporting the actuated block 162. Therefore, the actuated block 162 slides to and fro on the first guiding portion 172.

The two sliding supporters 150 are disposed on the two side plates 114 of the frame 110, i.e. the left side plate and the right side plate. An end of each sliding supporter 150 is connected to the screen supporting rack 250 behind the display screen 140, while the other end is connected to the actuated block 162. Thus, the actuated block 162 drives the two sliding supporters 150 and the display screen 140 moving in a horizontal direction. Although an actuator 160 driving the sliding supporter 150 at the right side is illustrated as an example, it is understood that the actuator 160 can further be used to drive both of the two sliding supporters 150, or two actuators can be used to respectively drive the two sliding supporters 150, which should not be construed as a limitation to the invention. Specifically, the sliding supporter 150 has a rail 152, and the side plate 114 of the frame 110 is provided with a second guiding portion 174, such as a guiding pin, arranged in the rail 152 for supporting the sliding supporter 150. Therefore, the sliding supporter 150 can move to and fro on the second guiding portion 174. The rail 152 has a horizontal section L1 and an inclined section L2 for defining a horizontal position and a destination position of the display screen 140, which are illustrated with the operation diagram of the liquid crystal display device, and thus omitted herein. Moreover, in order to drive the display screen 140 stably moving from the horizontal position to the destination position in the follow-up operation process, the actuated block 162 is provided with a vertical axle H, and a sleeve P of the sliding supporter 150 is disposed on the vertical axle H. Two ends of the vertical axle H are closed such that the sleeve P moves freely between the two ends of the vertical axle H. In addition, the actuated block 162 is connected to the sliding supporter 150 through the vertical axle H and the sleeve P and drives the sliding supporter 150 moving in the horizontal direction.

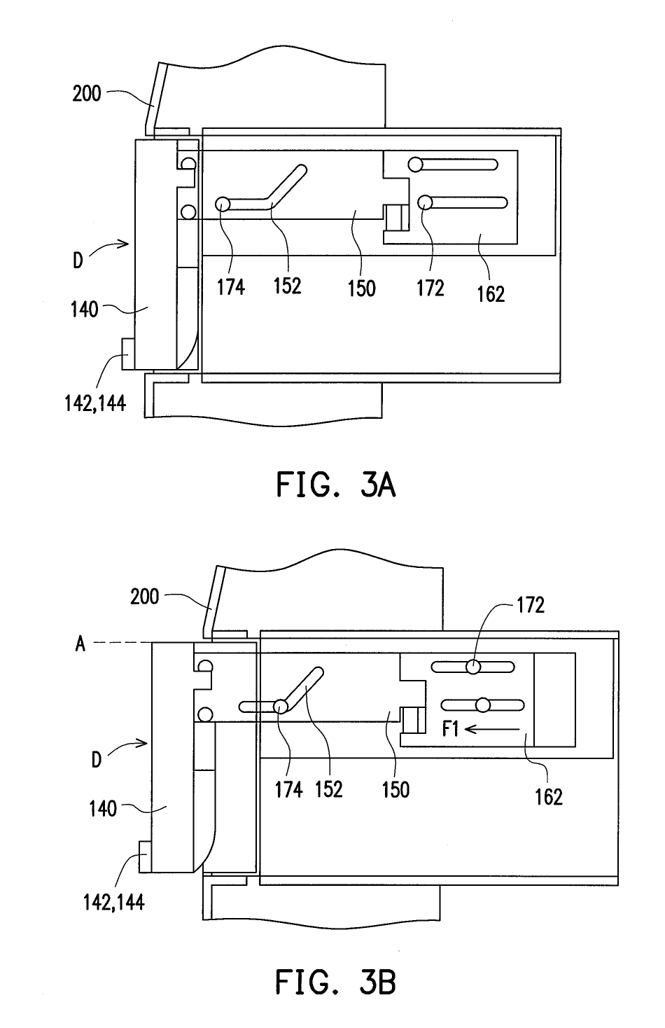

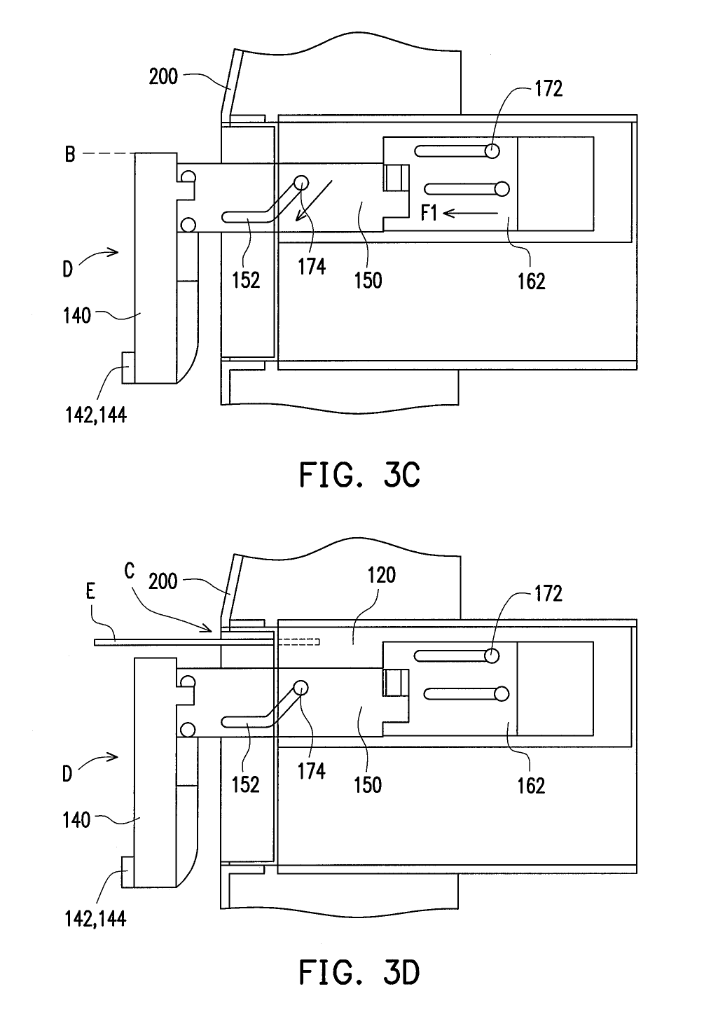

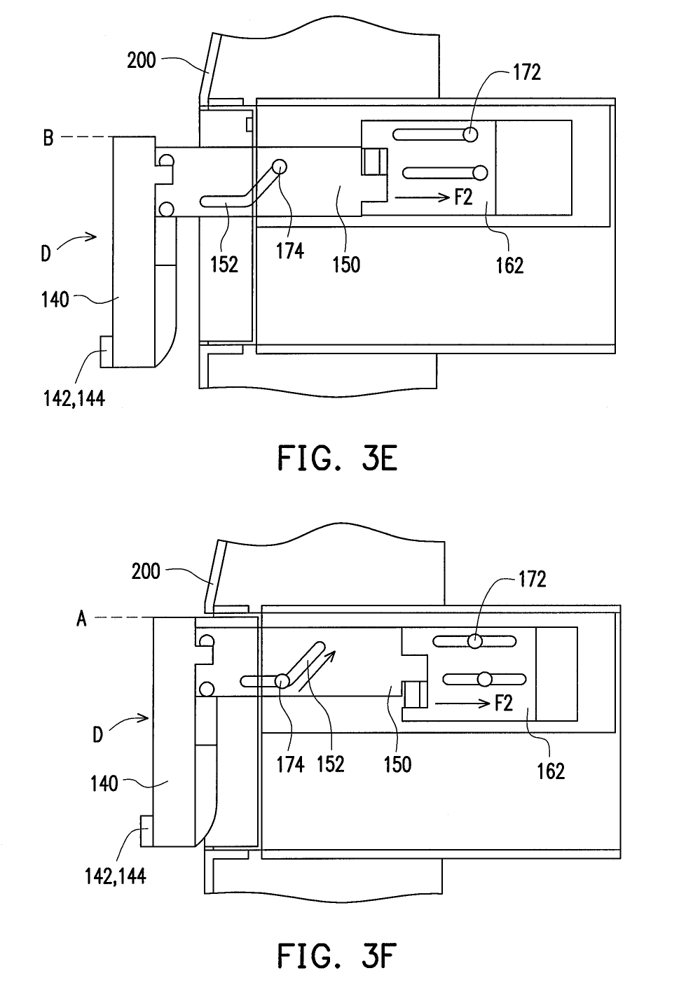

FIGS. 3A-3F show an operation process of a liquid crystal display device according to one embodiment of the invention. Firstly, referring to FIG. 3A, the display screen 140 is disposed in an opening of the panel 200. The display screen 140 has a display surface D parallel to the panel 200. Being favorably installed in the panel 200, a size of the display screen 140 conforms to a standard size of a 2DIN automotive stereo panel, such as 178 mm×100 mm, while a size of the host 120 conforms to a standard size of an 1DIN automotive stereo panel, such as 178 mm×50 mm, and thus there are available space below the host 120 to be utilized. In addition, the display screen 140 is provided with a start key for enabling the actuator 160 to drive the actuated block 162 moving along a first direction F.

Referring to FIG. 3B, when the actuated block 162 drives the sliding supporter 150 and display screen 140, the display screen 140 is located on the horizontal position A and moving outward from the panel 200. At this time, the second guiding portion 174 is located in the horizontal section L1 of the rail 152 with respect to the moving sliding supporter 150. Referring to FIG. 3C, when the actuated block 162 continues to move along the first direction F, the display screen 140 moves from the horizontal position A toward the destination position B. At this time, the second guiding portion 174 is located in the inclined section L2 of the rail 152 with respect to the moving sliding supporter 150.

Accordingly, the display screen 140 moves horizontally through the actuated block 162 and changes the moving direction by the inclined section L2 of the rail 152 of the sliding supporter 150 so as to perform a movement from the horizontal position A and downward to the destination position B Furthermore, the actuated block 162 and the sliding supporter 150 are provided with the vertical axle H and the sleeve P respectively, wherein the sleeve P moves along the vertical axle H to adjust the altitude of the sliding supporter 150, and therefore the display screen 140 can move stably from the horizontal position A to the destination position B along with the position variation of the sliding supporter 150.

Referring to FIG. 3D, when the display screen 140 reaches the destination position B, an opening C corresponding to the host 120 is formed above the display screen 140 to expose the host 120. By which, an user can put an optical disc E into the host 120 through the opening C to play the optical disc E and show a video with the host 120. Referring to FIGS. 3E and 3F, the display screen 140 is provided with a return key 144 for reversely driving the transmitting gear 164 of the actuator 160 and making the actuated block 162 moving along the second direction F2 (a reverse direction with respect to the first direction F1). At this time, the actuated block 162 drives the sliding supporter 150 and the display screen 140 moving from the destination position B back to the horizontal position A, and the second guiding portion 174 moves from the inclined section L2 to the horizontal diction L1. After that, the actuated block 162 continues moving reversely and drives the display screen 140 and the sliding supporter 150 moving along the horizontal direction to approach the opening of the panel 200. Finally, the display screen 140 returns to the original position as shown in FIG. 3A.

In summary, the liquid crystal display device drives the display screen outward the panel from the horizontal position to the destination position. Comparing with the conventional liquid crystal display devices, the display screen of the present invention has a shorter stroke and no more strike the shift lever in front of the panel. Furthermore, the display surface of the display screen always faces the user and the liquid crystal display device performs without flipping the display screen and thus devices on top of the display screen are no more obstructed. The display screen are no more retrieved and hidden within the panel, thus the required driving mechanism is simplified, the operation is simple and the reliability is therefore improved. In addition, there exists no requirement to reduce the size of the display screen, a standard size is preferred, and a larger and clearer displaying frame is provided. Moreover, the host can be hidden behind the display screen and exposed in using. Therefore, the available space of the panel is increased and the artistic appearance in the car is improved. The risk of being stolen or damaged of the host is dramatically reduced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A liquid crystal display device installed in a panel having an accommodating cavity, the liquid crystal display device comprising:
a display screen, having a display surface parallel to the panel;
two sliding supporters, connected to the display screen; and
an actuator, disposed on a frame accommodated in the accommodating cavity to drive the two sliding supporters and the display screen moving away from the panel horizontally from a horizontal position to a destination position.

2. The liquid crystal display device as claimed in claim 1, wherein the frame has a first guiding portion, and an actuated block of the actuator is slidably coupled to the first guiding portion.

3. The liquid crystal display device as claimed in claim 2, wherein the actuated block has a horizontal sliding slot, and the first guiding portion is installed in the horizontal sliding slot for supporting the actuated block.

4. The liquid crystal display device as claimed in claim 2, wherein the actuator has a transmitting gear coupled to a rack of the actuated block for driving the actuated block.

5. The liquid crystal display device as claimed in claim 4, wherein the actuator has an electric motor to drive the transmitting gear revolving.

6. The liquid crystal display device as claimed in claim 2, wherein the actuated block is provided with a vertical axle, and a sleeve of the sliding supporter is disposed on the vertical axle such that the actuated block connects and drives the sliding supporter.

7. The liquid crystal display device as claimed in claim 6, wherein the sleeve moves along the vertical axle to adjust the altitude of the sliding supporter.

8. The liquid crystal display device as claimed in claim 1, wherein the frame has a second guiding portion, and the sliding supporter is slidably coupled to the second guiding portion.

9. The liquid crystal display device as claimed in claim 8, wherein the sliding supporter has a rail, and the second guiding portion is installed in the rail for supporting the sliding supporter.

10. The liquid crystal display device as claimed in claim 9, wherein the rail has a horizontal section and an inclined section, when the display screen is on the horizontal position and moving outward the panel, the second guiding portion is in the horizontal section, and when the display screen approaches the destination position, the second guiding portion is in the inclined section.

11. The liquid crystal display device as claimed in claim 1, wherein the display screen is provided with a start key for enabling the actuator to drive the display screen moving from the horizontal position to the destination position.

12. The liquid crystal display device as claimed in claim 1, wherein the display screen is provided with a return key for enabling the actuator to drive the display screen moving from the destination position back to the horizontal position.

13. The liquid crystal display device as claimed in claim 1, wherein the display screen obstructs a host when locating at the horizontal position, while the display screen exposes the host with an opening when locating at the destination position.

14. The liquid crystal display device as claimed in claim 13, wherein the host is installed in the frame and electrically connected to the display screen.

15. The liquid crystal display device as claimed in claim 13, wherein the host comprises an optical disc drive.

16. The liquid crystal display device as claimed in claim 13, wherein the host comprises an automotive host.

17. The liquid crystal display device as claimed in claim 13, wherein a size of the display screen conforms to a standard size of a 2DIN automotive stereo panel.

18. The liquid crystal display device as claimed in claim 13, wherein a size of the host conforms to a standard size of an 1DIN automotive stereo panel.
